(19) United States
(12) Patent Application Publication
(10) Pub. No.: US 2026/0149209 A1
(43) Pub. Date: May 28, 2026

(54) CONNECTOR AND MALE TERMINAL

(71) Applicant: TOYOTA JIDOSHA KABUSHIKI KAISHA, Toyota-shi (JP)

(72) Inventors: Itsuo WAKABAYASHI, Toyota-shi (JP); Masaaki HAGITOU, Kakegawa-shi (JP); Ryosuke OHFUKU, Shimada-shi (JP)

(73) Assignee: TOYOTA JIDOSHA KABUSHIKI KAISHA, Toyota-shi (JP)

(21) Appl. No.: 19/293,419

(22) Filed: Aug. 7, 2025

(30) Foreign Application Priority Data
Nov. 26, 2024 (JP) 2024-205292

(51) Int. Cl. H01R 13/11; H01R 13/04

(52) U.S. Cl. CPC H01R 13/113; H01R 13/04

(57) ABSTRACT

A connector includes a female terminal including an insertion port, a first contact portion provided inside the insertion port, and a second contact portion provided inside the insertion port and biased in a direction substantially orthogonal to a biasing direction of the first contact portion, and a male terminal inserted into the insertion port, and including a pair of first side surfaces configured to contact the first contact portion, and a pair of second side surfaces configured to contact the second contact portion. The second contact portion is in contact with the male terminal on a side of the insertion port closer than the first contact portion, the first side surface has a first tapered surface inclined to be narrower toward a distal end. The second side surface has a second tapered surface inclined to be narrower toward the distal end.

### CROSS-REFERENCE TO RELATED APPLICATION

This application claims priority to Japanese Patent Application No. 2024-205292 filed on Nov. 26, 2024. The disclosure of the above-identified application, including the specification, drawings, and claims, is incorporated by reference herein in its entirety.

### BACKGROUND

### 1. Technical Field

The present disclosure relates to a female terminal including two contact portions, a connector including a male terminal insertable into the female terminal, and the male terminal.

### 2. Description of Related Art

Japanese Unexamined Patent Application Publication No. 2019-91711 (JP 2019-91711 A) discloses a terminal body including a female terminal and a male terminal inserted into the female terminal. The female terminal includes a bottom wall, a pair of side walls extending from the bottom wall to face each other, a main contact disposed along the bottom wall, and an arc discharge contact disposed forward of the main contact along each of the side walls. When the male terminal is inserted into the female terminal, the male terminal contacts at least one of the arc discharge contacts before the male terminal contacts the main contact, and arc discharge between the male terminal and the female terminal occurs at the arc discharge contact.

### SUMMARY

Even in a case where the arc discharge contact described in JP 2019-91711 A is provided, when the duration of the arc discharge is long, damage to the terminal may excessively proceed.

An object of the present disclosure is to provide a technique for suppressing damage to a terminal due to arc discharge.

In order to solve the above problem,

a connector according to any aspect of the present disclosure includes
a female terminal including an insertion port, a first contact portion provided inside the insertion port, and a second contact portion provided inside the insertion port and biased in a direction substantially orthogonal to a biasing direction of the first contact portion, and
a male terminal including a pair of first side surfaces configured to contact the first contact portion and a pair of second side surfaces configured to contact the second contact portion, the male terminal being inserted into the insertion port.
The second contact portion is in contact with the male terminal on a side closer to the insertion port than the first contact portion is, and
the first side surface has a first tapered surface inclined to be narrower toward a distal end.
The second side surface has a second tapered surface inclined to be narrower toward the distal end.

Another aspect of the present disclosure is a male terminal.

The male terminal is inserted into a female terminal including an insertion port, a first contact portion provided inside the insertion port, and a second contact portion provided inside the insertion port and biased in a direction substantially orthogonal to a biasing direction of the first contact portion, the male terminal including
a pair of first side surfaces configured to contact the first contact portion, and
a pair of second side surfaces configured to contact the second contact portion.
The first side surface has a first tapered surface inclined to be narrower toward a distal end.
The second side surface has a second tapered surface inclined to be narrower toward the distal end.

According to the present disclosure, a technique of suppressing damage to a terminal due to arc discharge can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a top view showing a male terminal of an embodiment;

FIG. 1B is a side view showing the male terminal of the embodiment;

FIG. 1C is a front view of the male terminal of the embodiment;

FIG. 2A is a cross-sectional view of a connector of the embodiment;

FIG. 2B is a cross-sectional view of the connector of the embodiment;

FIG. 3A is a diagram for describing a process in which the male terminal is inserted into the female terminal;

FIG. 3B is a diagram for describing a process in which the male terminal is inserted into the female terminal;

FIG. 3C is a diagram for describing a process in which the male terminal is inserted into the female terminal;

FIG. 3D is a diagram for describing a process in which the male terminal is inserted into the female terminal;

FIG. 3E is a diagram for describing a process in which the male terminal is inserted into the female terminal;

FIG. 3F is a diagram for describing a process in which the male terminal is inserted into the female terminal;

FIG. 4 is a graph showing a change in an insertion force during a process in which the male terminal is inserted into the female terminal; and

FIG. 5 is a graph showing a change in a disengagement force during a process in which the male terminal is disengaged from the female terminal.

### DETAILED DESCRIPTION OF EMBODIMENTS

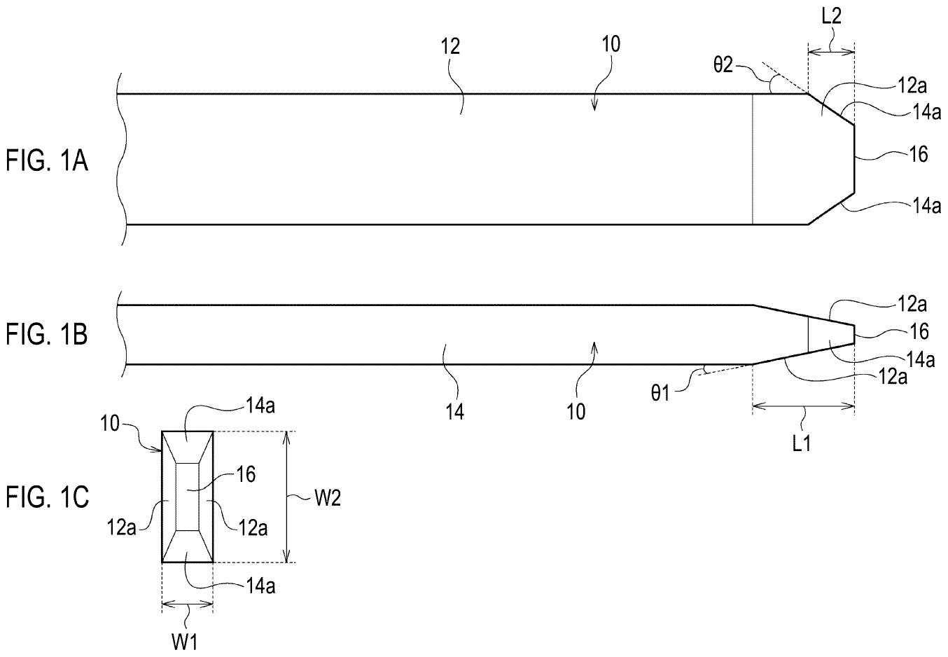

FIGS. 1A to 1C are diagrams showing a male terminal 10 of an embodiment. FIG. 1A is a top view of a male terminal 10, FIG. 1B is a side view of the male terminal 10, and FIG. 1C is a front view of the male terminal 10. The male terminal 10 is disposed into a female terminal to be described later to configure a connector and is electrically connected.

The male terminal 10 is provided in a quadrangular column shape and an elongated shape along a center axis. A cross section of the male terminal 10 is provided in a rectangular shape. The male terminal 10 has a first side surface 12, a second side surface 14, and a distal end 16. As shown in FIG. 1C, the distal end 16 is provided in a flat shape.

The male terminal 10 includes a pair of first side surfaces 12 and a pair of second side surfaces 14. The first side surface 12 and the second side surface 14 are continuous. The first side surface 12 has a first tapered surface 12a on the distal end 16 side. The second side surface 14 has the second side surface 14 on the distal end 16 side. The first side surfaces 12 extend in parallel, and the second side surfaces 14 extend in parallel. As shown in FIG. 1C, a first width W2 of the first side surface 12 is larger than a second width W1 of the second side surface 14.

The first tapered surfaces 12a are inclined to be narrower toward the distal end 16 and are inclined to be widened from the distal end 16 toward the base end side. The second tapered surfaces 14a are inclined to be narrower toward the distal end 16 and are inclined to be widened from the distal end 16 toward the proximal end side. By providing the second tapered surface 14a as well as the first tapered surface 12a, insertion into the female terminal is facilitated and disengagement from the female terminal is also accelerated.

A first inclination angle θ1 of the first tapered surface 12a is smaller than a second inclination angle θ2 of the second tapered surface 14a. The second inclination angle θ2 is set in a range of 40 degrees to 50 degrees. The first inclination angle θ1 is set in a range of 15 degrees to 25 degrees. In any case, the first inclination angle θ1 of the first tapered surface 12a is smaller than the second inclination angle θ2 of the second tapered surface 14a by 15 degrees or more.

A length L1 of the first tapered surface 12a in the longitudinal direction is longer than a length L2 of the second tapered surface 14a in the longitudinal direction. That is, the first tapered surface 12a extends in the longitudinal direction to a position farther from the distal end 16 than the second tapered surface 14a. That is, the second tapered surface 14a is shorter than the first tapered surface 12a.

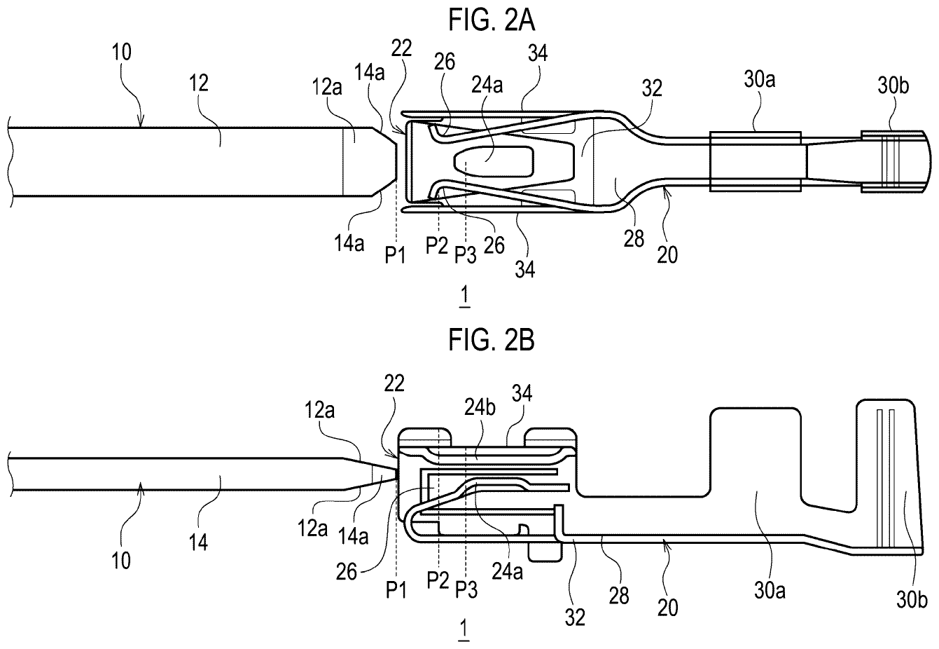

FIGS. 2A and 2B are cross-sectional views of the connector 1 of the embodiment. FIG. 2A is a cross-sectional view of the connector 1 taken along the second side surface 14, and FIG. 2B is a cross-sectional view of the connector 1 taken along the first side surface 12. The female terminal 20 includes an insertion port 22, a first contact portion 24a, a first contact portion 24b, a second contact portion 26, a base portion 28, a first connection portion 30a, and a second connection portion 30b.

The base portion 28 has a bottom portion 32 and a pair of side wall portions 34. The side wall portions 34 are erected from both edges of the bottom portion 32 and are positioned to face each other. An insertion port 22 is provided at a first end of the female terminal 20, and a second connection portion 30b is provided at a second end of the female terminal 20. The side wall portion 34 is positioned on the first end side. The first connection portion 30a and the second connection portion 30b are positioned on the second end side and are erected from the base portion 28. The first connection portion 30a and the second connection portion 30b are connected to an electric wire and can be crimped for connection to the electric wire.

The insertion port 22 is positioned at the first end of the female terminal 20 and allows insertion of the male terminal 10. The first contact portion 24a and the first contact portion 24b shown in FIG. 2B are positioned to face each other. The first contact portion 24a extends from the bottom portion 32 of the base portion 28 and is bent to be folded back on the insertion port 22 side. The first contact portion 24a is cantilevered, and a distal end thereof is a free end, and is provided to be more easily bent than the first contact portion 24b. The first contact portion 24b is supported by the side wall portions 34 on both sides. The first contact portion 24a is bendable in a facing direction. The first contact portion 24a and the first contact portion 24b may be simply referred to as the first contact portion 24 in general.

The second contact portion 26 is provided on each of the side wall portions 34 and is provided in a pair. The second contact portion 26 is provided to cut out the side wall portion 34 and is a cantilever extending from the first end side. A pair of second contact portions 26 are bent from the root toward the first end to approach each other and are bent in a direction in which the distal end sides are separated from each other. The second contact portions 26 are bendable in the facing direction.

The first contact portion 24 and the second contact portion 26 are positioned inside the insertion port 22. A direction in which the first contact portion 24 is biased and a direction in which the second contact portion 26 is biased are substantially orthogonal to each other. An opening of the insertion port 22 is at a first position P1.

A second position P2 indicates a position where the second contact portion 26 contacts the male terminal 10. A third position P3 indicates a position where the first contact portion 24 is in contact with the male terminal 10. The second contact portion 26 contacts the male terminal 10 on the insertion port 22 side than the first contact portion 24.

The male terminal 10 is inserted into the insertion port 22. The first side surfaces 12 are in contact with the first contact portion 24. The second side surfaces 14 are in contact with the second contact portion 26. The female terminal 20 accepts the male terminal 10, the first contact portion 24 biases the first side surfaces 12, and the second contact portion 26 biases the second side surfaces 14. A biasing force of the first contact portion 24 is greater than a biasing force of the second contact portion 26.

When the male terminal 10 is pulled out in the state in which the male terminal 10 is inserted into the female terminal 20, the contact at the second contact portion 26 is supported when the contact with the first contact portion 24 is released, and then the contact with the second contact portion 26 is released. Therefore, even in a case where the arc discharge occurs, the arc discharge does not occur in the first contact portion 24, and occurs in the second contact portion 26. The first contact portion 24 is a contact portion for electrical conduction, and the second contact portion 26 is a contact portion for arc discharge.

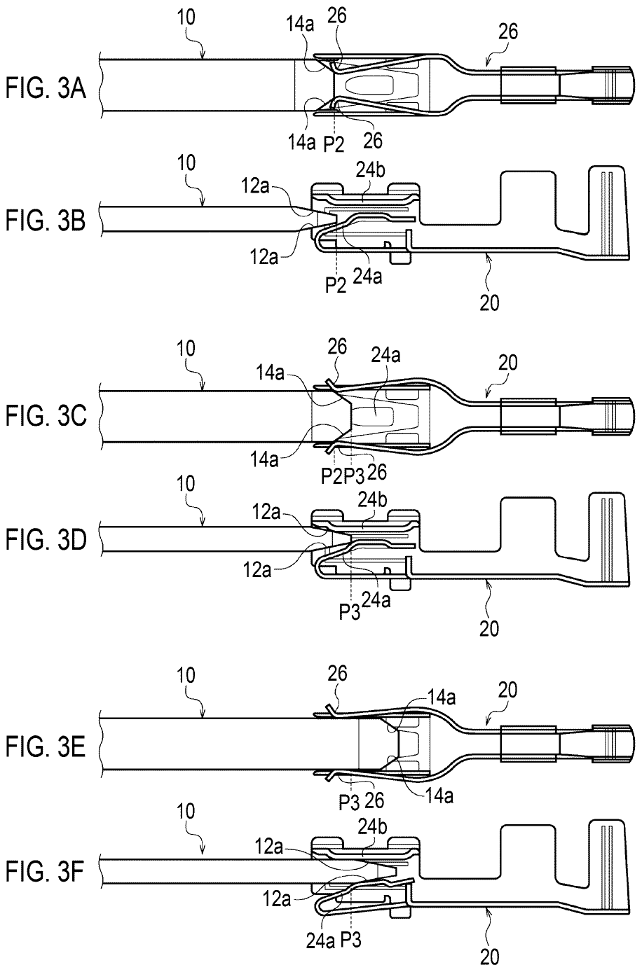

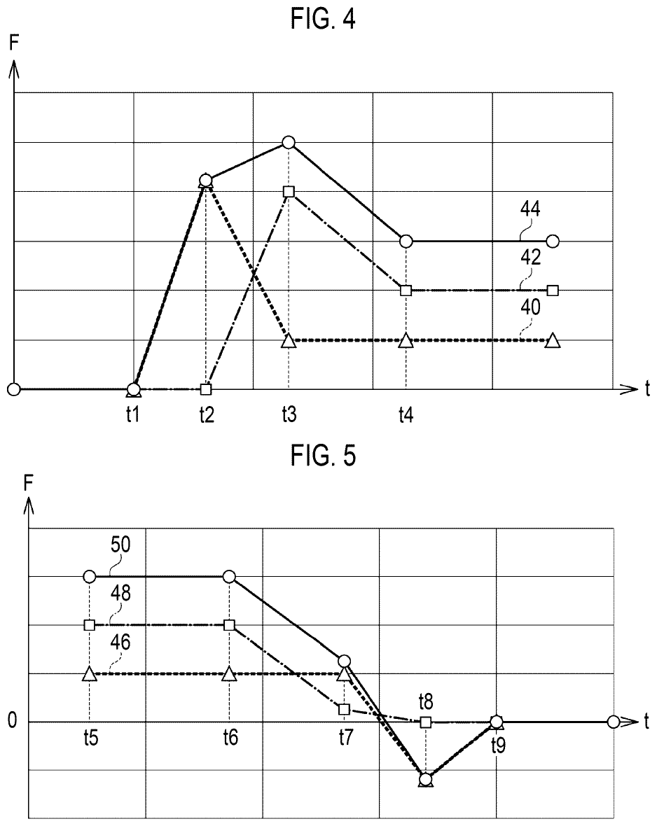

FIGS. 3A to 3F are diagrams for describing a process in which the male terminal 10 is inserted into the female terminal 20. FIG. 4 is a diagram showing a change in the insertion force during the process in which the male terminal 10 is inserted into the female terminal 20.

A vertical axis shown in FIG. 4 indicates an insertion force F, and a horizontal axis indicates a time t. FIG. 4 shows a second insertion force 40 generated in the second side surface 14 and the second contact portion 26, a first insertion force 42 generated in the first side surface 12 and the first contact portion 24, and a total insertion force 44 obtained by adding the second insertion force 40 and the first insertion force 42.

FIGS. 3A and 3B show a state in which the distal end 16 of the male terminal 10 is disposed to the second position P2. At time t1 shown in FIG. 4, the distal end 16 of the male terminal 10 shown in FIGS. 3A and 3B is disposed to the second position P2, and the second tapered surface 14a of the second side surface 14 starts to contact the second contact portion 26 to receive the biasing force.

From time t1 to time t2, the second insertion force 40 applied to the second contact portion 26 increases. Since the first insertion force 42 applied to the first contact portion 24 does not increase, the total insertion force 44 is the same as the second insertion force 40. The second insertion force 40 smoothly increases by the second tapered surface 14a. Therefore, the male terminal 10 can be smoothly inserted without being caught by the second contact portion 26, and the time for the arc discharge to occur can be shortened.

FIGS. 3C and 3D show a state in which the distal end 16 of the male terminal 10 is disposed to the third position P3. Reaching the third position P3 by the distal end 16 corresponds to time t2 in FIG. 4. Time t2 is a timing at which the first tapered surface 12a is started to be biased from the first contact portion 24.

From time t2 to time t3, the second insertion force 40 applied to the second contact portion 26 decreases. The reason is that the second tapered surface 14a reaches the peak of the second contact portion 26 at time t2, and passes the peak of the second contact portion 26 after time t2. The second insertion force 40 decreases as the second tapered surface 14a passes through the peak of the second contact portion 26. The peak of the second contact portion 26 is at a position where the second contact portions 26 are closest to each other or in the vicinity thereof.

From time t2, the first insertion force 42 applied to the first contact portion 24 increases. From time t2, the first tapered surface 12a receives the biasing force from the first contact portion 24, and reaches the peak of the first contact portion 24 at time t3.

When the first tapered surface 12a and the first contact portion 24 come into contact with each other, the first insertion force 42 is generated as a result. When the second tapered surface 14a and the second contact portion 26 come into contact with each other, the second insertion force 40 is generated as a result. The first insertion force 42 and the second insertion force 40 overlap in a decreasing region where the first insertion force 42 decreases from a peak at time t2, and an increasing region where the second insertion force 40 increases toward a peak at time t2, and the insertion force in the increasing region is larger than the insertion force in the decreasing region. Therefore, from time t2 to time t3, the total insertion force 44 increases without decreasing. As a result, the peak of the total insertion force 44 becomes one at time t3. The user can easily recognize the completion of the mounting and can smoothly insert the male terminal 10 into the female terminal 20.

FIGS. 3E and 3F show a state in which the distal end 16 of the male terminal 10 is inserted deeper than the third position P3. The first tapered surface 12a is about to exceed a third position P3, and the first tapered surface 12a and the first insertion force 42 of the first contact portion 24 reach a peak. At time t3 shown in FIG. 4, the first insertion force 42 reaches a peak.

From time t3 to time t4, the first insertion force 42 decreases and the second insertion force 40 is constant. Therefore, the total insertion force 44 decreases as the first insertion force 42 decreases. From time t4, the first insertion force 42 and the second insertion force 40 are constant, and the total insertion force 44 is also constant.

As described above, the total insertion force 44 generated when the male terminal 10 is inserted into the female terminal 20 has a single peak at time t3. The reason is that the first insertion force 42 starts to increase before time t2 when the second insertion force 40 reaches the peak, and the first insertion force 42 is larger than the second insertion force 40 from time t2 to time t3.

FIG. 5 is a graph showing a change in a disengagement force during a process in which the male terminal 10 is disengaged from the female terminal 20. A vertical axis shown in FIG. 5 shows a disengagement force F, and a horizontal axis shows a time t. FIG. 5 shows a second disengagement force 46 generated in the second side surface 14 and the second contact portion 26, a first disengagement force 48 generated in the first side surface 12 and the first contact portion 24, and a total disengagement force 50 obtained by adding the second disengagement force 46 and the first disengagement force 48. The disengagement process shown in FIG. 5 is a reverse process of the insertion process shown in FIGS. 3A to 3F, and will be described with reference to FIGS. 3A to 3F.

An operator pulls the male terminal 10 from the female terminal 20 at time t5. From time t5 to time t6, the first disengagement force 48 and the second disengagement force 46 are constant. At time t6, the first contact portion 24 starts to push the first tapered surface 12a, and the first disengagement force 48 starts to decrease.

At time t7, the second contact portion 26 starts to push the second tapered surface 14a, and the second disengagement force 46 starts to decrease. The second contact portion 26 is separated from the female terminal 20 without pulling the male terminal 10 when the force with which the second contact portion 26 presses the second tapered surface 14a is greater than the frictional force, and the second disengagement force 46 becomes zero or less. At time t8, since the second disengagement force 46 decreases and the first disengagement force 48 is close to zero, the total disengagement force 50 is zero or less. Since the second inclination angle θ2 of the second tapered surface 14a is large, the proportion of the biasing force of the second contact portion 26 converted into the disengagement force is large.

As a result, the time for the second tapered surface 14a and the second contact portion 26 to be in contact with each other when the male terminal 10 is disengaged is shortened. Therefore, even in a case where the arc discharge occurs between the second tapered surface 14a and the second contact portion 26, the duration of the arc discharge can be shortened, and the influence of the arc discharge can be reduced.

The present disclosure has been described based on the embodiment. The present disclosure is not limited to the above-described embodiment, and various modifications, such as design changes, can be made based on the knowledge of those skilled in the art.

Although an aspect has been described in which the second tapered surface 14a of the embodiment is provided as a flat surface, the aspect is not limited thereto, and the second tapered surface 14a may be provided to be curved concavely. As a result, when the male terminal 10 is disengaged, a force acting in a disengagement direction can be momentarily increased.

What is claimed is:

1. A connector comprising:
a female terminal including an insertion port, a first contact portion provided inside the insertion port, and a second contact portion provided inside the insertion port and biased in a direction substantially orthogonal to a biasing direction of the first contact portion; and
a male terminal including a pair of first side surfaces configured to contact the first contact portion and a pair of second side surfaces configured to contact the second contact portion, the male terminal being inserted into the insertion port, wherein:
the second contact portion is in contact with the male terminal on a side closer to the insertion port than the first contact portion is;
the first side surface has a first tapered surface inclined to be narrower toward a distal end; and
the second side surface has a second tapered surface inclined to be narrower toward the distal end.

2. The connector according to claim 1, wherein a first inclination angle of the first tapered surface is smaller than a second inclination angle of the second tapered surface.

3. The connector according to claim 1, wherein:
the male terminal is provided in an elongated shape; and
the first tapered surface extends farther from a distal end of the male terminal than the second tapered surface in a longitudinal direction.

4. The connector according to claim 1, wherein:
the first contact portion is configured to bias the first tapered surface when the male terminal is inserted;
the second contact portion is configured to bias the second tapered surface when the male terminal is inserted; and
a decreasing region where an insertion force that is generated by contact between the second tapered surface and the second contact portion decreases after passing a peak and an increasing region where an insertion force that is generated by contact between the first tapered surface and the first contact portion increases toward a peak overlap, and the insertion force in the increasing region is greater than the insertion force in the decreasing region.

5. A male terminal inserted into a female terminal including an insertion port, a first contact portion provided inside the insertion port, and a second contact portion provided inside the insertion port and biased in a direction substantially orthogonal to a biasing direction of the first contact portion, the male terminal comprising:
a pair of first side surfaces configured to contact the first contact portion; and
a pair of second side surfaces configured to contact the second contact portion, wherein:
the first side surface has a first tapered surface inclined to be narrower toward a distal end; and
the second side surface has a second tapered surface inclined to be narrower toward the distal end.
